(19) United States
(12) Patent Application Publication
(10) Pub. No.: US 2007/0130450 A1
(43) Pub. Date: Jun. 7, 2007

(54) Unnecessary dynamic branch prediction elimination method for low-power

(75) Inventors: Wei-Hau Chiao, Hsinchu Hsien (TW); Yau-Chong Hu, Hsinchu Hsien (TW); Chung-Ping Chung, Hsinchu Hsien (TW); Jean Jyh-Jiun Shann, Hsinchu Hsien (TW); Chia-Wen Cheng, Hsinchu Hsien (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/450,404

(22) Filed: Jun. 12, 2006

(30) Foreign Application Priority Data
Dec. 1, 2005 (TW) 094142240

(51) Int. Cl. G06F 9/00

(52) U.S. Cl. 712/239

(57) ABSTRACT

A system and method for unnecessary dynamic branch prediction elimination in a processor with a dynamic branch predictor, includes a branch distance generation module for generating a branch distance between two consecutive branch instructions, a branch distance table for storing the branch distance generated by the branch distance generation module, and a dynamic branch predictor enabling module for determining enable or disable the dynamic branch prediction by using the branch distances stored in the branch distance table for the next incoming instructions. Through the configuration of the system, the dynamic branch prediction is performed only for branch instruction, so as to save power consumption due to unnecessary dynamic branch predictions.

### FIELD OF THE INVENTION

The present invention relates generally to methods and systems for reducing power and energy consumption of processors, and more particularly, to an unnecessary dynamic branch prediction elimination method and system for low-power.

### BACKGROUND OF THE INVENTION

Recently, portable computing and communication devices become widespread. While most of these devices are battery-powered, plus their functional requirements due to users are ever-increasing, low power design for these systems hence becomes a very important research topic.

Almost all processors are highly pipelined today. To reduce stall cycles due to program flow changes, most processor cores adopt dynamic branch prediction techniques. Dynamic branch prediction is typically performed at the first pipeline stage to eliminate pipeline stalls due to branches. A drawback arises here: since the fetched instruction cannot be identified as a branch or not at this stage, the dynamic branch predictor is always exercised. Worse yet, the branch target buffer (BTB), which contains branch target addresses, is a large storage with both tag and data random access memories (RAMs). The power-hungry nature of the above discourages use of dynamic branch prediction in many portable devices. Nevertheless, due to its success in performance designs, dynamic branch prediction is also very attractive to processors for power-miser applications. Low-power issues for dynamic branch predictors hence become important research topics.

Since branch instructions constitute only a small portion of all executed instructions, most dynamic branch prediction operations are useless and only waste power. How these useless branch prediction operations can be eliminated is the focus of this research area.

US Patent Application Publication No. 2004/0181654 [LOW POWER BRANCH PREDICTION TARGET BUFFER] discloses a method, which is applicable to a pipelined processor having at least a first stage for performing instruction fetch and branch prediction operations, and a second stage for processing instructions fetched by the first stage, and the method comprises the first stage fetching a first instruction; obtaining branch prediction enabling information from the first instruction; passing the first instruction on to the second stage; enabling or disabling at least a portion of a branch prediction circuitry for the second instruction which follows the first instruction, according to the branch prediction enabling information; and the first stage performing the instruction fetch and branch prediction operations according to the second instruction. The branch prediction operation is performed upon the second instruction by the branch prediction circuitry according to the branch prediction enabling information encoded within the first instruction. The method, through the adoption of an instruction encoding technique or the generation of an instruction sequence, utilizes unused opcode in an instruction to inform a processor of enabling or disabling the branch target buffer.

However, the prior art technique has to modify instruction set architecture to eliminate the branch target buffer accesses.

### SUMMARY OF THE INVENTION

A primary objective of the present invention is to provide an unnecessary dynamic branch prediction elimination method, which is a pure hardware-based method.

Another objective of the present invention is to provide a system and method for unnecessary dynamic branch prediction elimination, without the need of modifying program codes, system software, or instruction set architecture (ISA).

Still another objective of the present invention is to provide a system and method for unnecessary dynamic branch prediction elimination, which are capable of handling incorrect predictor access due to branch misprediction.

In accordance with the foregoing and other objectives, the present invention provides a system and method for unnecessary dynamic branch prediction elimination in a processor, comprising: a branch distance generation and collection module for generating and collecting a branch distance between two consecutive branch instructions on the execution path; a branch distance table for storing the branch distance generated by the branch distance generation module; and a dynamic branch predictor enabling module for enabling the dynamic branch prediction or not by using the branch distances stored in the branch distance table.

In one exemplary embodiment, the method and system of unnecessary dynamic branch prediction elimination is power efficient, since most dynamic branch predictions of non-branch instructions are eliminated.

In one exemplary embodiment, the branch distance generation and collection module of the unnecessary dynamic branch prediction elimination system identifies whether an executed instruction is a branch instruction, calculates the number of non-branch instructions (branch distance) in-between the two adjacent executed branch instructions, and stores the generated branch distance into the branch distance table.

In one exemplary embodiment, the dynamic branch predictor enabling module of the unnecessary dynamic branch prediction elimination system further comprises an enable counter recording a number of upcoming non-branch instructions before a next sequential branch instruction is fetched. The enable counter is initialized to the branch distance value of the current branch instruction according to the predicted branch direction. Then, in the following non-branch instruction cycles, the dynamic branch predictions are eliminated and the enable counter value is decremented, such that the dynamic branch prediction is performed only when the enable counter value reaches zero.

In one exemplary embodiment, a dynamic branch prediction system may further comprise an incorrect predictor access handling module for recovering incorrect enable counter values due to branch misprediction. The incorrect predictor access handling module makes a backup of the correct branch distance for incorrect predictor accesses recovering, such that when branch misprediction happens, the backup branch distance value is loaded into the enable counter, and the pipeline is flushed and restarted in the correct branch direction.

In one exemplary embodiment, a method for unnecessary dynamic branch prediction elimination includes the processes of: generating and collecting the branch distance between two consecutive executed branch instructions; and determining enable or disable the dynamic branch prediction by using the branch distances stored in the branch distance table for the next incoming instructions; and recovering the incorrect enable counter values due to branch misprediction.

In one exemplary embodiment, a process for generating and collecting the branch distance between two consecutive branch instructions further includes the steps of determining whether or not an executed instruction is a branch instruction; if so, the current branch distance generation counter value is the generated branch distance of the previous executed branch instruction, and store the branch distance generation counter value into branch distance table and then reset the branch distance counter value to zero for the branch distance calculation of current branch instruction; Otherwise, increment the current branch distance generation counter value for calculating the number of non-branch instructions.

In one exemplary embodiment, a process for determining whether to enable or disable the dynamic branch prediction according to the branch distances stored in the branch distance table for the next incoming instructions, further includes the steps of: looking up the branch distance table; if hit, fetching the branch distance of the current instruction according to the predicted branch direction from the branch distance table and storing the fetched branch distance into the enable counter, or if miss, decrementing the enable counter value by one. After the above steps, the dynamic branch prediction enabling/disabling signal for the next instruction can be generated according to the enable counter value. The dynamic branch prediction enabling signal for the next instruction is generated only when the enable counter value is zero. Otherwise, the dynamic branch prediction disable signal is generated.

In one exemplary embodiment, a process for recovering the incorrect enable counter values due to branch misprediction further includes the steps of: backup the branch distance of another branch direction when fetching the branch distance from the branch distance table according to the predicted branch direction. Then, if branch misprediction is happened, the backup branch distance value is used to recover the enable counter.

Compared with dynamic branch prediction techniques of the prior art, the system and method of dynamic branch prediction of the present invention employ a branch distance generation module, a branch distance table, a dynamic branch prediction enabling module and an incorrect predictor access handling module to avoid useless dynamic branch predictions. The system and the method can be implemented by hardware without the need for modifying program codes, system software, or ISA. Moreover, if branch misprediction is happened, the present invention may recover the incorrect predictor accesses due to branch misprediction. Therefore, the branch prediction accuracy is not affected if the processor installed the unnecessary dynamic branch prediction elimination system.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF DRAWINGS

The present invention can be more fully understood by reading the following detailed description of the preferred embodiments, with reference made to the accompanying drawings, wherein:

FIG. 1 is a block diagram illustrating a processor having a dynamic branch predictor and a unnecessary dynamic branch prediction elimination system co-functioning with the dynamic branch predictor according to an exemplary embodiment of the present invention; and

FIGS. 2 to 4 are flow charts depicting the general processes of a method for dynamic branch prediction according to the present invention.

### DETAILED DESCRIPTION OF THE PREFERRED EMBODIMENTS

The following embodiments are described in sufficient detail to enable those skilled in the art to make and use the invention. It is to be understood that other embodiments would be evident based on the present disclosure, and that proves or mechanical changes may be made without departing from the scope of the present invention.

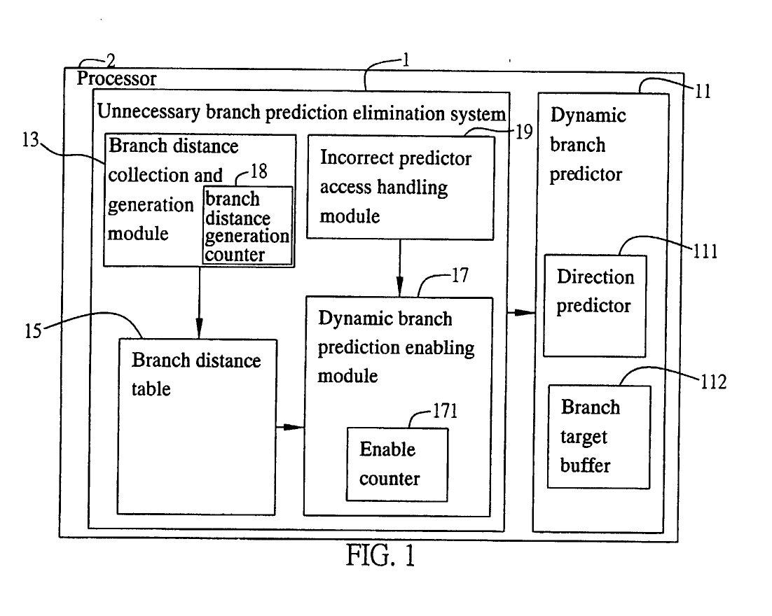

FIG. 1 is a block diagram of a processor 2 having a dynamic branch predictor 11 and an unnecessary dynamic branch prediction elimination system 1 co-functioning with the dynamic branch predictor 11 according to an exemplary embodiment according to the present invention. The unnecessary dynamic branch prediction elimination system 1 comprises a branch distance generation and collection module 13, a branch distance table 15, a dynamic branch prediction enabling module 17 and an incorrect predictor access handling module 19.

In a preferred embodiment, a term “branch distance (BD)” is defined as a number of non-branch instructions between two consecutive branch instructions. If the processor 2 is revealed the BD of branch instructions early, dynamic branch prediction operations associated with the in-between non-branch instructions can be avoided. In general, the dynamic branch predictor 11 comprises a direction predictor 111 and a branch target buffer (BTB) 112. Various implementations of the direction predictor 111 use different ways to record the branch status and use it to predict the branch direction. Furthermore, hybrid implementations integrate several sub-predictors to improve prediction accuracy and are widely used in general-purpose processors for desktops or workstations. The BTB 112, which is used for recording target addresses, is a cache in nature. If the BTB 112 hits and the branch direction is predicted taken, the branch target address is used as the next PC. Otherwise, the next sequential instruction address (PC+4) is used. A dynamic branch predictor in an embedded processor usually integrates the direction predictor 111 and the BTB 112. Two branch history bits in each entry of BTB represent possible prediction states. The exemplary dynamic branch predictor 11, the direction predictor 111, and the branch target buffer 112 are not limited to that described and illustrated, and not used to limit the claim scope of the unnecessary dynamic branch prediction elimination method and system thereof of the present invention.

The branch distance generation and collection module 13 is used to generate the branch distance in-between the two consecutive executed branch instructions, and store the generated branch distance into the branch distance table.

The branch distance table 15 is used to store the branch distance calculated by the branch distance generation and collection module 13.

The dynamic branch predictor enabling module 17 is used to enable or disable the dynamic branch prediction for the next incoming instruction. In the preferred embodiment, the dynamic branch predictor enabling module 17 further comprises a enable counter 171 used for recording a number of upcoming non-branch instructions before a next sequential branch instruction is encountered. The dynamic branch predictor enabling module 17 lookups the branch distance table 15. If hit, fetch the branch distance of the current instruction according to the predicted branch direction from the branch distance table 15 and store the fetched branch distance into the enable counter 171. If miss, the enable counter value is decrement by one. After the above steps, the dynamic branch prediction enabling/disabling signal for the next instruction can be generated according to the enable counter value. The dynamic branch prediction enabling signal for the next instruction is generated only when the enable counter value is zero. Otherwise, the dynamic branch prediction disable signal is generated.

The incorrect predictor access handling module 19 is used for recovering incorrect enable counter values due to branch misprediction. The incorrect predictor access handling module 19 backs up the branch distance of another branch direction when fetching the branch distance from branch distance table 15 according to the predicted branch direction. Then, if branch misprediction happens, the backup branch distance value can be used to recover the enable counter 171.

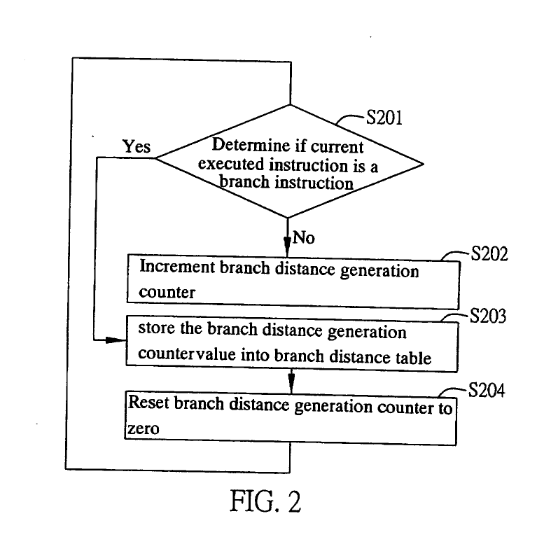

FIGS. 2 to 4 are flow charts depicting the general processes of a method for dynamic branch prediction according to the present invention.

The method starts in step S201. In step S201, the branch distance generation and collection module 13 identifies whether an executed instruction is a branch instruction. If no, proceed to step S202, or else proceed to step S203.

In step S202, increment branch distance generation counter.

In step S203, calculate the number of non-branch instructions (branch distance) in-between the two adjacent executed branch instructions, and store the generated branch distance into the branch distance table 15. Proceed to step S204.

In step S204, the branch distance generation counter 18 to zero.

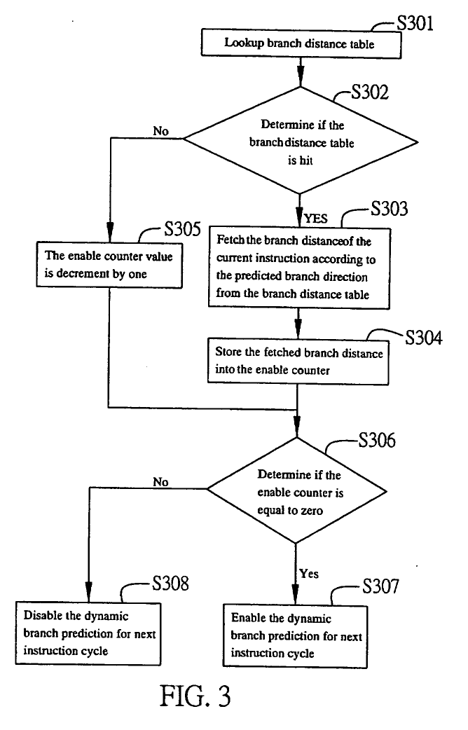

Refer to FIG. 3. In step S301, the dynamic branch predictor enabling module 17 lookups the branch distance table 15. Proceed to step S302.

In step S302, determine if the branch distance table 15 is hit. If hit, proceed to step S303, or else proceed to step S305.

In step S303, fetch the branch distance of the current instruction according to the predicted branch direction from the branch distance table 15. Proceed to step S304.

In step S304, store the fetched branch distance into the enable counter 171. Proceed to step S306.

In step S305, decrement the enable counter value by one. Proceed to step S306.

In step S306, determine if the enable counter is equal to zero. If yes, proceed to step S307, or else proceed to step S308.

In step S307, enable the dynamic branch prediction for next instruction cycle.

In step S308, disable the dynamic branch prediction for next instruction cycle.

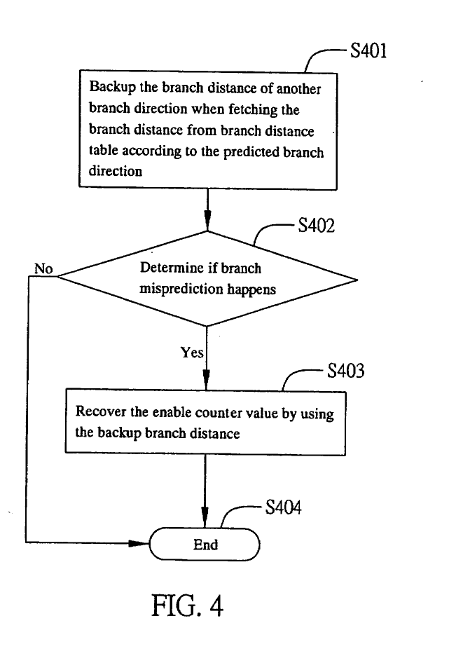

Refer to FIG. 4. In step S401, backup the branch distance of another branch direction when fetching the branch distance from branch distance table according to the predicted branch direction. Proceed to step S402.

In step S402, determine if branch misprediction happens. If yes, proceed to step S403 or else, proceed to step S404.

In step S403, recover the enable counter value by using the backup branch distance. Proceed to step S404.

In step 404, the method ends.

The unnecessary dynamic branch prediction elimination method and system can be implemented in any pipelined processor with dynamic branch prediction support. We use MIPS five stage (IF, ID, EXE, MEM, and WB) pipeline processor for example, where the dynamic branch prediction performed at the IF stage, and the branch status and the target address is updated at the EXE stage.

During the EXE stage, the instruction type can be easily identified by the control signals generated in ID stage. Therefore, the branch distance calculation becomes trivial and the branch distance generation and collection module 13 can be implemented in this stage.

The dynamic branch prediction operation is performed at the IF stage. If the processor 2 is reveled the branch distance at this stage, the dynamic branch prediction enabling signal generation becomes trivial. Therefore, the dynamic branch predictor enabling module 17 can be implemented at the IF stage. If the predicted path of a branch instruction has been executed before, the branch distance value can be found in branch distance table 15 and the branch predictions of the following non-branch instruction can be easily disabled.

The correct branch direction and next PC for the branch instruction is resolved at EXE stage. Therefore, the misprediction signal is generated at this stage. The instructions at formal stages (IF and ID stage) are flushed immediately and the instruction fetcher may fetch the correct instruction by using the resolved next PC. If the branch distance of another direction can be backed up when fetching the branch distance from branch distance table 15 according to the predicted branch direction, the error enable counter value due to branch misprediction can be easily recovered immediately.

The simplest implementation of branch distance table 15 is described here. Each entry has three fields: a branch field is used for branch instruction identification, an NT_D field is used to save the branch distance on not taken path, and a T_D field is the branch distance of taken path. Therefore, the generated branch distance generated by the branch distance generation and collection module 13 can be stored in its associated fields.

The BTB-based implementation of branch distance table 15 appended the T_D and NT_D fields to their corresponding BTB entries. In this implementation, the branch distance fetching and storing operations are integrated into BTB lookup and update operations respectively.

In summary, the system and method for unnecessary dynamic branch prediction elimination according to the present invention comprises the branch distance generation and collection module 13, the branch distance table 15, the dynamic branch predictor-enabling module 17 and the incorrect predictor access handling module 19, and mechanisms of using the same. This thereby allows the system and the method to dynamically generate and collect branch distances in a program and eliminate dynamic branch predictions for non-branch instructions through the design of a hardware structure, without modifying original program codes, system software, or instruction set architecture. Moreover, the present invention may not affect the branch prediction accuracy.

Compared with the prior art (US Publication No. 2004/0181654), the present invention does not need to change ISA. Moreover, the present invention also does not need to change system software, complier or program codes.

The invention has been described using exemplary preferred embodiments. However, it is to be understood that many alternatives, modifications, and variations will be apparent to those skilled in the art in light of the foregoing description. Accordingly, it is intended to embrace all such alternatives, modifications, and variations that fall within the scope of the included claims. All matters hithertofore or shown in the accompanying drawings are to be interpreted in an illustrative and non-limiting sense.

1. A system for unnecessary dynamic branch prediction elimination in a processor with a dynamic branch predictor having a direction predictor for branch direction prediction and a branch target buffer for storing branch target addresses, the system comprising:
a branch distance generation module for generating a branch distance between two consecutive branch instructions;
a branch distance table for storing the branch distance generated by the branch distance generation module;
a dynamic branch predictor enabling module for enabling the dynamic branch prediction or not by using the branch distances stored in the branch distance table; and
an incorrect predictor access handling module for preventing incorrect dynamic branch predictor accesses due to branch misprediction.

2. The system of claim 1, wherein the dynamic branch predictor enabling module comprises an enable counter for recording a number of upcoming non-branch instructions before a next branch instruction is fetched.

3. The system of claim 2, wherein the enable counter value is processed according the branch distance table lookup status; and if hit, fetch the branch distance of the current instruction according to the predicted branch direction from the branch distance table and store the fetched branch distance into the enable counter, and if miss, the enable counter value is decremented by one.

4. The system of claim 2, wherein the dynamic branch predictor enabling module does not enable the dynamic branch prediction for the next instruction until the enable counter counts a number equal to zero.

5. The system of claim 1, wherein the incorrect predictor access handling module backs up the branch distance of another branch direction when fetching the branch distance from branch distance table according to the predicted branch direction such that when branch misprediction happens, the backup branch distance value is loaded into the enable counter to recover the error branch distance value due to branch misprediction immediately.

6. The system of claim 1, wherein the branch distance generation and collection module comprises a branch distance generation counter for branch distance generation and collection.

7. The system of claim 6, wherein the branch distance generation and collection module generates the branch distance value by checking the instruction type is branch or not; and if yes, the current branch distance generation counter value is the branch distance value of the previous branch instruction, and if no, the branch distance is continuously generated by incrementing the branch distance generation counter.

8. The system of claim 6, wherein the branch distance generation and collection module collects the branch distance by storing the generated branch distance into the branch distance table.

9. The system of claim 1, wherein the branch distance table can be implemented by a number of entries where each entry comprises:
a Branch field used for branch instruction identification, and
an NT_D field used for saving the branch distance on not taken path, and
a T_D field being the branch distance of taken path.

10. The system of claim 8, the generated branch distance of previous branch instruction is stored into its associated fields in branch distance table.

11. The system of claim 1, wherein the branch distance table can be implemented by extending two fields of each BTB fields, wherein the extended fields are:
an NT_D field used for save the branch distance on not taken path, and
a T_D field being the branch distance of taken path.

12. The system of claim 3, wherein the branch distance fetching and storing operations are integrated into BTB lookup and update operations respectively.

13. The system of claim 1, wherein the branch distance generation and collection module can be implemented in the pipeline stage after in the instruction type decoding.

14. The system of claim 1, wherein dynamic branch predictor enabling module can be implemented in the pipeline stage that dynamic branch prediction is performed.

15. A method for unnecessary dynamic branch prediction elimination in a processor with a dynamic branch predictor having a direction predictor for branch direction prediction and a branch target buffer for storing branch target addresses, the method comprising:
having a branch distance generation module to generate a branch distance between two consecutive branch instructions;
having a branch distance table to store the branch distance generated by the branch distance generation module;
having a dynamic branch predictor enabling module to enable the dynamic branch prediction or not by using the branch distances stored in the branch distance table; and
having an incorrect predictor access handling module to prevent incorrect dynamic branch predictor accesses due to branch misprediction.

16. The method of claim 15, wherein the dynamic branch predictor enabling module comprises an enable counter for recording a number of upcoming non-branch instructions before a next branch instruction is fetched.

17. The method of claim 16, wherein the enable counter value is processed according the branch distance table lookup status; and if hit, fetch the branch distance of the current instruction according to the predicted branch direction from the branch distance table and store the fetched branch distance into the enable counter, and if miss, the enable counter value is decremented by one.

18. The method of claim 16, wherein the dynamic branch predictor enabling module does not enable the dynamic branch prediction for the next instruction until the enable counter counts a number equal to zero.

19. The method of claim 15, wherein the incorrect predictor access handling module backs up the branch distance of another branch direction when fetching the branch distance from branch distance table according to the predicted branch direction such that when branch misprediction happens, the backup branch distance value is loaded into the enable counter to recover the error branch distance value due to branch misprediction immediately.

20. The method of claim 15, wherein the branch distance generation and collection module comprises a branch distance generation counter for branch distance generation and collection.

21. The method of claim 20, wherein the branch distance generation and collection module generates the branch distance value by checking the instruction type is branch or not; and if yes, the current branch distance generation counter value is the branch distance value of the previous branch instruction, and if no, the branch distance is continuously generated by incrementing the branch distance generation counter.

22. The method of claim 20, wherein the branch distance generation and collection module collects the branch distance by storing the generated branch distance into the branch distance table.

23. The method of claim 15, wherein the branch distance table can be implemented by a number of entries where each entry comprises:
a Branch field used for branch instruction identification, and
an NT_D field used for saving the branch distance on not taken path, and
a T_D field being the branch distance of taken path.

24. The method of claim 22, the generated branch distance of previous branch instruction is stored into its associated fields in branch distance table.

25. The method of claim 15, wherein the branch distance table can be implemented by extending two fields of each BTB fields, wherein the extended fields are:
an NT_D field used for save the branch distance on not taken path, and
a T_D field being the branch distance of taken path.

26. The method of claim 17, wherein the branch distance fetching and storing operations are integrated into BTB lookup and update operations respectively.

27. The method of claim 15, wherein the branch distance generation and collection module can be implemented in the pipeline stage after in the instruction type decoding.

28. The method of claim 15, wherein dynamic branch predictor enabling module can be implemented in the pipeline stage that dynamic branch prediction is performed.
